(19) United States
(12) Patent Application Publication
(10) Pub. No.: US 2015/0314287 A1
(43) Pub. Date: Nov. 5, 2015

(54) FLOW CHANNEL DEVICE, METHOD FOR MANUFACTURING FLOW CHANNEL DEVICE, AND METHOD FOR INSPECTING FLOW CHANNEL DEVICE

(71) Applicant: CANON KABUSHIKI KAISHA, Tokyo (JP)

(72) Inventor: Eishi Igata, Washington, NY (US)

(21) Appl. No.: 14/698,715

(22) Filed: Apr. 28, 2015

(30) Foreign Application Priority Data
Apr. 30, 2014 (JP) 2014-093890

(51) Int. Cl. B01L 3/00; G01N 19/04

(52) U.S. Cl. CPC B01L 3/502707; G01N 19/04; B01L 2200/12; B01L 2300/0877; B01L 2300/0887

(57) ABSTRACT

A device and a method for reducing man-hours for the inspection of a bonding in a flow channel device including a hollow flow channel disposed therein by bonding a plurality of substrates together. A flow channel device includes a plurality of hollow flow channels established by bonding substrates together in an overlapping manner, with at least one of the substrates including a plurality of grooves on a surface of the substrate, wherein a depressed shape at which bonding quality can be determined is provided at a position different from positions of the flow channels on at least one of the surfaces of the bonded substrates.

### BACKGROUND

1. Field of the Invention

The present disclosure relates to a flow channel device in which it is possible to determine the quality of a bonding state.

2. Description of the Related Art

In analytical chemistry, it is fundamental to obtain desired information such as a concentration or an ingredient to confirm the progresses and the results of chemical and biochemical reactions. Various apparatuses and sensors for obtaining such information have been invented. There is a concept termed Micro Total Analysis Systems (μ-TAS) or a lab-on-a-chip, which miniaturizes such an apparatus or sensor to achieve on a micro device all the processes until desired information is obtained. This concept aims to cause a collected raw material or an unpurified specimen to pass through a flow channel in a micro device, and perform the process of purifying the specimen or the process of causing a chemical reaction in the flow channel, thereby obtaining the final chemical compound or the concentration of an ingredient contained in the specimen. Further, a micro device for governing such analyses and reactions inevitably deals with minute amounts of solution and gas, and therefore is often termed a micro flow channel device or a microfluidic device.

Generally, a micro flow channel device is formed by bonding a flat substrate having a thickness of several millimeters or less and a surface area of several centimeter square or more, with a substrate including grooves having cross-sectional dimensions of 10 to 1000 micrometers on its surface, and a flat plate serving as the ceiling or the bottom of flow channels. Examples of the bonding method include heat welding of substrates, anodic bonding, and ultrasonic bonding, a method of pressure-bonding substrates together after excimer laser irradiation, a method of pressure-bonding substrates by softening the surfaces of the substrates using a solvent, and a bonding method using an adhesive layer. Examples of the method for determining the quality of bonding by these methods include inspection methods such as a method of causing a solution to flow through formed flow channels, and a method of observing the entire bonding surface using a microscope to determine whether a poorly bonded part is present. Further, Japanese Patent Application Laid-Open No. 11-328756 (FIG. 2) discusses the following method. As in a microfluidic device, in an object that requires the bonding of a thin substrate with an object having a large area, such as a dual-layer digital video disc, part of a bonding surface is observed, thereby determining the quality of the entire bonding surface.

When micro flow channels have been formed, it is necessary to determine bonding quality. As the method for inspecting the bonding quality, generally, a method of injecting a solution into the flow channels and observing leakage and blockage, or the visual observation of all the flow channels using a microscope is performed.

However, as the shapes of flow channels become complex as a result of the higher integration of microfluidic devices, a conventional method requires a large number of inspection man-hours. Consequently, the inspection of an individual device could be a bottleneck in the manufacturing process.

Further, the bonding inspection method discussed in Japanese Patent Application Laid-Open No. 11-328756 (FIG. 2), in which only part of a bonding surface is observed, is a method of observing the vicinity of grooves present in a transparent portion near the center of a digital video disc and confirming air bubbles present in the vicinity of the grooves and the protrusion of an adhesive, thereby determining the bonding quality of the entire surface of the disc. If, however, a plurality of grooves are present over a wide range and an adhesive has been applied to between the grooves, the observation of the vicinity of the grooves in the central portion does not represent the entire surface of the disc. Thus, it is difficult to determine the bonding quality of the entirety of the surface.

### SUMMARY

Disclosed herein is a flow channel device typified by a micro flow channel and a method for inspecting the same, in which it is possible to determine the quality of a bonding state of substrates bonded together.

According to the present disclosure, a flow channel device includes a plurality of hollow flow channels established by bonding substrates together in an overlapping manner, with at least one of the substrates including a plurality of grooves on a surface of the substrate, wherein a depressed shape at which bonding quality can be determined is provided at a position different from positions of the flow channels on at least one of the surfaces of the bonded substrates.

According to another aspect of the present disclosure, a method for inspecting bonding quality of a flow channel device including a hollow flow channel disposed therein by bonding substrates together in an overlapping manner, at least one of the substrates including a groove on a surface of the substrate, the method includes generating an air bubble surrounded by an adhesive at a position different from a position of the flow channel, and observing a reduction of a size of the air bubble.

According to the present disclosure, it is possible, by observing a shape present in part of a bonding surface, to determine the quality of bonding of the entire surface forming a plurality of flow channels. This can reduce inspection man-hours.

Further features of the present invention will become apparent from the following description of exemplary embodiments with reference to the attached drawings.

### BRIEF DESCRIPTION OF THE DRAWINGS

FIGS. 1A and 1B are conceptual diagrams illustrating a principle of the disclosure.

FIG. 2 is a cross-sectional diagram illustrating the principle of the disclosure.

FIG. 3 is a cross-sectional diagram illustrating the principle of the disclosure.

FIG. 4 illustrates a device configuration disclosed herein.

FIG. 5 is a graph illustrating an experimental result of the present disclosure.

FIG. 6 is an inspection shape.

FIG. 7 is an inspection shape.

FIG. 8 illustrates an inspection shape used to verify concepts disclosed herein when an adhesive is used.

FIG. 9 is a graph illustrating an experimental result of the present disclosure.

FIG. 10 illustrates an inspection shape using an adhesive.

FIG. 11 illustrates an inspection shape used to verify thermocompression bonding according to the present disclosure.

FIG. 12 illustrates an apparatus according to an embodiment disclosed herein.

### DESCRIPTION OF THE EMBODIMENTS

The present invention will be described in detail below.

A device disclosed herein is a flow channel device including a plurality of hollow flow channels disposed therein by bonding substrates together in an overlapping manner, at least one of the substrates including a plurality of grooves on a surface of the substrate, wherein on the surface of the at least one of the bonded substrates, a depressed shape enabling determination of the bonding quality is provided at a position different from positions of the flow channels.

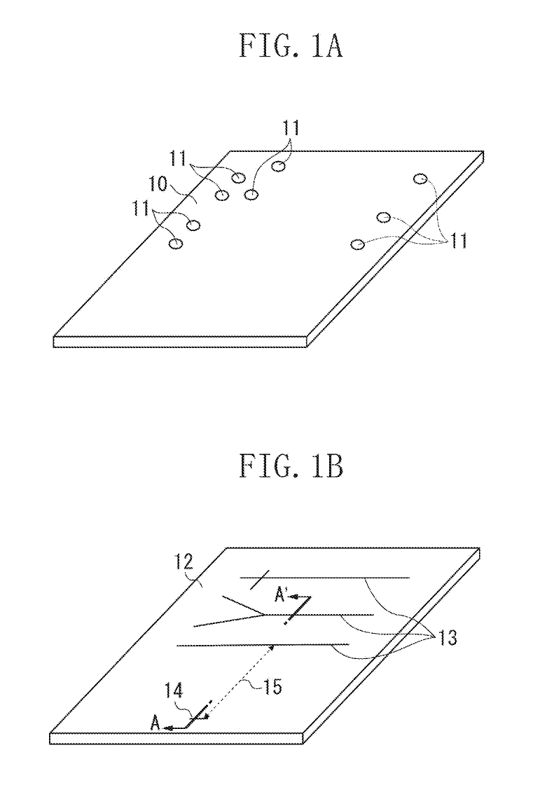

For further details, with reference to FIGS. 1A, 1B, 2, 3, 4, and 5, a shape for inspecting the blockage of flow channels when substrates are bonded together with an adhesive will be described.

In FIG. 1A, a plurality of holes 11 are opened through a substrate 10. A substrate to be bonded with the substrate 10 with an adhesive is a substrate 12 illustrated in FIG. 1B. The substrate 12 includes grooves 13 and an inspection shape 14 on its surface. A distance 15 is defined as a distance between the inspection shape 14 and one of the grooves 13 closest to the inspection shape 14. An adhesive is applied to the substrate 10, the substrate 10 is placed on the substrate 12 in such a manner that the end portions of the grooves 13 approximately coincide with the centers of the plurality of holes 11, and the substrates 10 and 12 are bonded together while being pressurized. At this time, if the adhesive enters the grooves 13 by the pressurization, flow channels to be formed are blocked. This cannot result in appropriate bonding.

The material of the substrates 10 and 12 is, for example, glass or plastic. The width of each groove 13 may be approximately several micrometers to 1 millimeter. The method for manufacturing the grooves 13 depends largely on the material of the substrates. For example, in the case of glass, microfabrication using photolithography can be employed. In the case of plastic, injection molding, hot embossing, or drilling can be employed. The method, however, is not particularly limited.

Examples of the adhesive include an ultraviolet (UV) curing type adhesive, a thermosetting type adhesive, and a two-component curing type adhesive. In view of affinity with the substrate 10, an adhesive that can be uniformly applied at a thickness of approximately several micrometers is desirable. For example, if the substrate 10 is made of hydrophilic glass, it is desirable that the adhesive should also be hydrophilic. Among adhesives, an ultraviolet curing type adhesive is particularly desirable because of the advantage of high curing speed. However, an ultraviolet curing type adhesive needs to be irradiated with ultraviolet light through the substrate 10. In this case, a substrate that absorbs little amount of ultraviolet light may be used as the substrate 10, or the thickness of the substrate 10 may be limited.

In the pressurization for bonding the substrates, pressure may not be concentratedly applied only at a single point of the device, but may be applied across the overall width of the device. This is to prevent the distance between the surfaces of the substrates from being affected by the process of pressurization if a pressure is applied at a point.

It is desirable that when a plurality of substrates are bonded together with the adhesive, the thickness of the adhesive should be approximately several micrometers so that the substrates are bonded together without the adhesive blocking micro flow channels, each having a depth of several tens to several hundreds of micrometers. The details will be described below. To achieve this thickness, a method for dissolving an adhesive in a solvent and spin-coating the substrate with the adhesive solution, or spray-coating the substrate with the adhesive solution, or dip-coating the substrate with the adhesive solution, or printing the adhesive solution on the substrate can be employed. However, the method is not particularly limited.

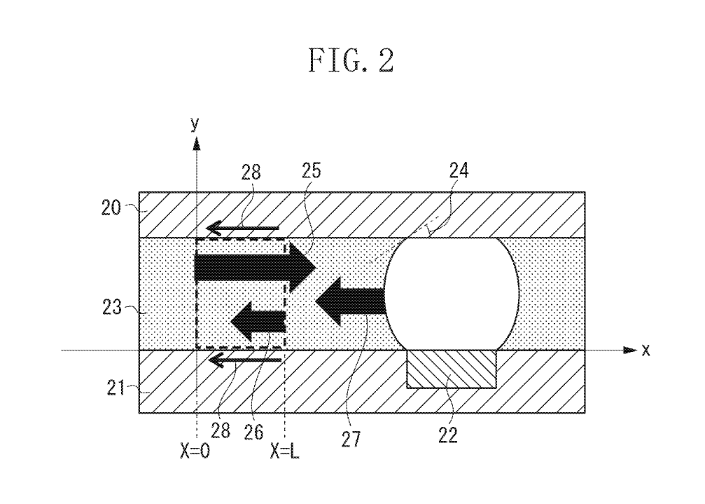

FIG. 2 illustrates a cross-sectional view of the state of uncured adhesive near the flow channel when a hollow flow channel is formed using an adhesive. FIG. 2 illustrates a substrate 20, and a substrate 21 which includes a groove 22 on its surface. An adhesive 23 has a contact angle 24 with the substrate 20. Further, after the substrates 20 and 21 are bonded together with the adhesive 23 to be approximately parallel to each other, the groove 22 is referred to as a flow channel 22. Two-dimensional orthogonal coordinate axes are set in such a manner that the origin is as illustrated in FIG. 2. When, in a minute range between the positions of x=0 and x=L, the adhesive 23 is moving at a constant speed in the direction of the flow channel 22, a force F (25) is acting in the direction toward the flow channel 22, and a force F₀ (26) is acting at the position of x=L as a reaction to the force F (25). Further, a frictional force f (28) acts at the interfaces between the adhesive 23 and the substrates and 21. This state is expressed by the following formula (1).

F−F₀−f (1)

Meanwhile, a surface tension ST (an arrow 27) of the adhesive 23 acts in the direction opposite to that of the flow of the adhesive 23 at the interface between the adhesive 23 and the flow channel 22. If the surface tension ST (the arrow 27) is greater than the total of the forces causing the flow of the adhesive 23, the adhesive 23 does not enter the flow channel 22. Thus, the following formula (2) is a condition under which the adhesive 23 does not fill the flow channel 22.

F−F₀−f<ST (2)

When a force acting on a unit area at the position of x=0 is denoted as p₀, the force F is expressed by formula (3).

F=p₀dw (3)

In formula (3), d represents the thickness of the adhesive 23, and w represents the length in the depth direction of the plane of the paper.

Next, when a force acting on a unit area at the position of X=L is denoted as p_{L}, the following relationship expressed by formula (4) is established.

F₀=−p_{L}dw=−{p₀+(dp/dx)L}dw=−{p₀−aL}dw (4)

In formula (4), a=−dp/dx, and −dp/dx is the pressure gradient.

The frictional force f is proportional to the speed of the adhesive 23, and therefore can be expressed by the following formula (5).

f=2wLμ(du/dy) (5)

In formula (5), u represents the speed of the adhesive 23 in the x-direction, and μ represents the viscosity of the adhesive 23.

The speed profile of a fluid flowing between parallel substrates forms a parabolic profile having a vertex at the midpoint between the substrates.

Between the parallel substrates 20 and 21, f is expressed by the following formula (6).

f=−μ(8wLU₀/d) (6)

In formula (6), U₀ represents a maximum speed U₀=ad²/8μ in the speed profile.

Further, the surface tension ST (the arrow 27 in FIG. 2), which is generated between the flow channel 22 and the adhesive 23, is expressed by the following formula (7).

ST=2wT cos θ (7)

In formula (7), T represents the surface tension of the adhesive 23.

Finally, when these formulas are substituted in F−F₀−f<ST to solve d, the following relationship expressed by formula (8) is established.

$$d < \frac{T cos θ + \sqrt{{( T cos θ )}^{2} + aL * 8 {µ Ug}_{0} L}}{aL} \qquad ( 8 )$$

At this time, generally, the viscosity of the adhesive 23 is several hundreds of mPa·s or more, which is much higher than the viscosity of water (1 mPa·s). The flow rate of the adhesive 23 is very small when the substrates 20 and 21 have actually been bonded together with the adhesive 23. When U₀ is approximated to 0, the above formula (8) is expressed by the following formula (9).

d<2T cos θ/(aL) (9)

In other words, it is understood that the determination of whether the adhesive 23 fills the flow channel 22 depends on the inverse relationship between the thickness of the adhesive 23 and the distance from the wall of the flow channel 22.

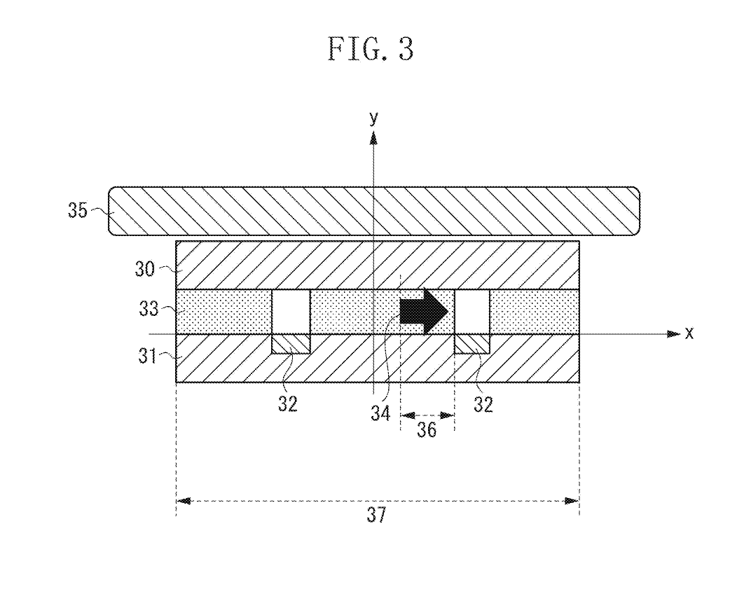

Further, as illustrated in FIG. 3, the pressure gradient a is the pressure generated when substrates 30 and 31 are pressurized and bonded together. On the assumption that pressure propagates isotropically in an adhesive 33, pressure p₀ (an arrow 34) acting in the x-axis direction can be expressed by the following formula (10).

$${p}_{0} = \frac{2 ( M + m ) g}{{L}_{R} {W}_{D}} \frac{L ( x )}{{W}_{D}} \qquad ( 10 )$$

In formula (10), M represents the mass of a weight 35, m represents the mass of the substrate 30, g represents the gravitational acceleration, L_{R} represents the distance at which the weight 35 and the substrate 30 are in contact with each other in the depth direction of the plane of the paper, W_{D} (an arrow 37) represents the overall width of the fluidic device, and L(x) (an arrow 36) represents the distance from the wall of a flow channel 32. In the above formula expressing p₀, the first term is obtained by dividing the force due to the weight 35 and the substrate 30 by a contact area L_{R}W_{D} of the weight 35 and the substrate 30. The coefficient 2 is the sum of the force of pressurizing the substrate 30 and the force imparted by the substrate 31 as a reaction to the pressurizing force. Further, the second term represents the proportion of the distance from the wall of the flow channel 32 to the overall width W_{D} of the fluidic device. Accordingly, the following relationship expressed by the following formula (11) is established.

a=−dp₀/dx=2(M+m)g/(L_{R}W_{D}²) (11)

Finally, this is substituted in d<2Tcos θ/(aL) to obtain the following formula (12).

$$d < \frac{{L}_{R} {W}_{D}^{2}}{( M + m ) g} \frac{T cos θ}{L ( x )} \qquad ( 12 )$$

In the above formula (12), all the values can be controlled.

It is understood from this formula that there is an inverse relationship between the thickness d of the adhesive and the distance L(x) from the wall of the flow channel. Thus, when L(x) is increased, the adhesive enters the flow channel unless d is decreased.

In other words, by appropriately setting the distance 15 (illustrated in FIG. 1B) between the inspection shape 14 and the wall of the closest flow channel 13, it is possible to create a situation where an adhesive easily blocks a flow channel.

More specifically, if the position where the inspection shape is disposed is a position satisfying the relationship expressed by the following formula (13) where the distance from the wall of one of the flow channels is denoted as L, a thickness of a material for bonding the substrates is denoted as d, the surface tension of the material is denoted as T, a contact angle between the material and the surface of a substrate is denoted as θ, a mass of an object for pressing substrate is denoted as M, a width of the object is denoted as L_{R}, a mass of the substrate is denoted as m, a width of the device is denoted as W_{D}, and a gravitational acceleration is denoted as g, it is possible to provide a flow channel device that enables easy determination of the quality of the bonding state and to certainly achieve an excellent bonding state.

$$L < \frac{{L}_{R} {W}_{D}^{2}}{( M + m ) g} \frac{T cos θ}{d} \qquad ( 13 )$$

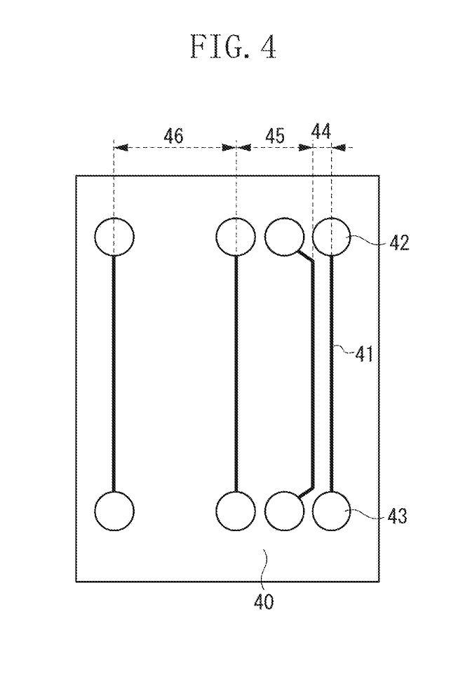

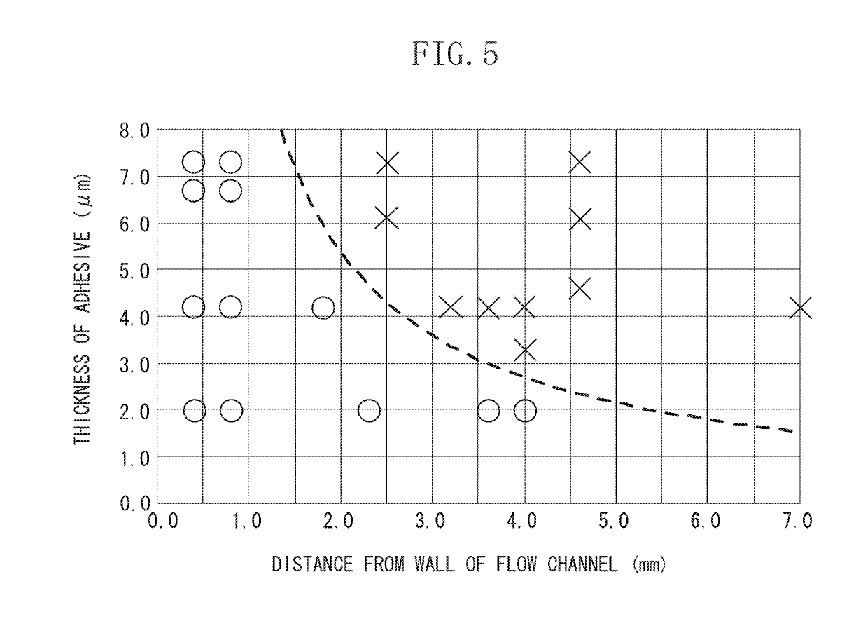

To confirm the formula (13), as illustrated in FIG. 4, a plurality of grooves were formed on the surface of a flat polymethylmethacrylate (PMMA) substrate. The flat PMMA substrate was bonded with another flat PMMA substrate with an adhesive, whereby each groove formed a hollow flow channel. As illustrated in FIG. 4, flow channel devices were manufactured in such a manner that the distances between the walls of adjacent flow channels are different. Flow channels 41, each having a width of 100 μm and a depth of 50 μm, solution injection holes 42, each having a diameter of approximately 1 mm, and solution discharge holes 43, each having a diameter of approximately mm, were formed on a single PMMA substrate 40. The plurality of flow channel devices were manufactured in such a manner that distances 44, 45, and 46 between the walls of the flow channels 41 and the walls of the adjacent flow channels 41 were, for example, 0.4 mm, 1.7 mm, and 2.5 mm, respectively. FIG. 4 is a conceptual diagram, and the detailed distances and the detailed thicknesses of the adhesive are illustrated in a graph in FIG. 5.

As the adhesive, for example, ultraviolet curing resin World Rock 5541 (registered trademark) (manufactured by Kyoritsu Chemical & Co., Ltd.; a viscosity of 2000 mPa·s) was used. This adhesive was applied to the substrate 40 at a thickness in the range of approximately 2 to 7 μm. The substrate 40 was bonded with a flat substrate, and immediately after that, the adhesive was irradiated with approximately 3000 mJ/cm² of ultraviolet light at an irradiation density of 50 mW/cm² to cure. Finally, the states of the flow channels 41 after the irradiation of ultraviolet light were observed using a microscope, and the entry of the adhesive into the flow channels 41 was observed.

FIG. 5 illustrates a graph indicated by a dashed line calculated by introducing into the formula (13) the contact angle (θ: up to 36°) between the adhesive and the substrate used in the present exemplary embodiment, the overall width of the device (W_{D}: up to 40 mm), the contact length (L_{R}: up to 1 mm) of the weight and the substrate, the mass (M: up to 610 g) of the weight, the mass (m: up to 1.3 g) of the substrate, and the surface tension (T: up to 50 mN/m) of the adhesive. Further, the flow channels 41 were observed using a microscope after the irradiation of ultraviolet light. For a value with which the adhesive entered the flow channels 41, “x” was marked. For a value with which the adhesive did not enter the flow channels 41, “∘” was marked.

The experimental result in FIG. 5 coincides well with the formula written by the formula (12). It has been verified that the greater the distance from the wall of the flow channel, the smaller the thickness of the adhesive needs to be. Otherwise, the adhesive easily enters the flow channel. Further, it has been verified that, if the adhesive has the same thickness, the smaller the distance from the wall of the flow channel, the more easily the entry of the adhesive into the flow channel is prevented. Further, if the thickness of the adhesive is 1 μm or less, the adhesive does not enter the flow channel even if the distance from the wall of the flow channel is 7.0 mm or more. However, a gap caused by the unevenness of the surfaces of the substrates, which is typified by a burr generated in molding, was observed.

In the present invention, using the above principle, the inspection shape 14 is provided at a position out of contact with flow channels for processing a specimen. If the blockage of the inspection shape 14 has not been confirmed when bonding state is inspected in the device, it is possible to determine that the flow channels are not blocked either. Thus, it is possible, only by observing an inspection shape, to determine appropriate bonding in which flow channels are not blocked. This leads to a significant reduction in man-hours for the inspection of the bonding.

The present invention is described more specifically below with exemplary embodiments. The following exemplary embodiments are merely examples for describing the present invention in further detail, and exemplary embodiments are not limited only to the following exemplary embodiments.

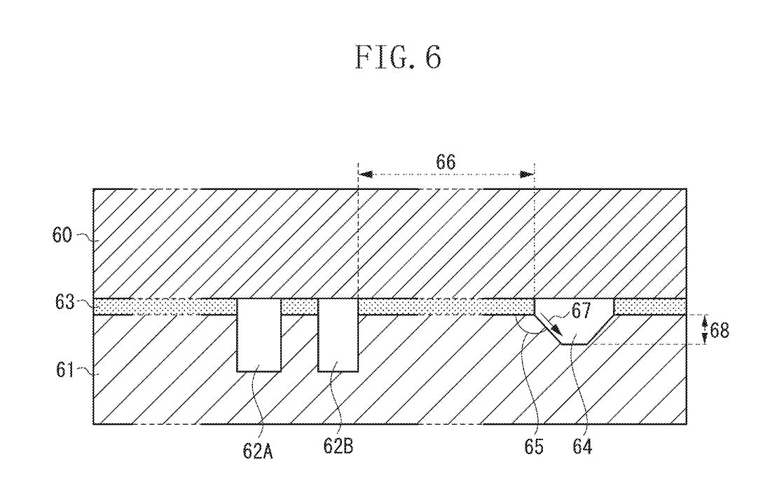

A first exemplary embodiment will be described with reference to FIG. 6 illustrating a cross section taken along the line A-A′ illustrated in FIG. 1B. In FIG. 6, a substrate 60 is bonded with a substrate 61 via an adhesive 63. The cross-sectional dimensions, i.e., the depth and the width, of each of flow channels 62A and 62B are both several tens to several hundreds of micrometers and may be optionally set.

An inspection shape 64, which is similar to a flow channel, is provided at a position where a distance L (66) from the flow channel 62B matches the formula (12). As described above, if the distance L (66) matches the formula (12), an angle θ (65) of the inspection shape 64 may be 90°, similarly to the flow channel 62B, or less. In FIG. 6, the distance L (66) between the inspection shape 64 and the flow channel 62B is sufficiently great. Thus, the adhesive 63 flows more easily into the inspection shape 64 than into the flow channels 62A and 62B, which are provided at positions adjacent to each other. Thus, the inspection shape 64 is more easily blocked than the flow channels 62A and 62B. Thus, when bonding is inspected, the blockage of the inspection shape 64 may only need to be observed. Then, if the inspection shape 64 is not blocked, this can be an indicator that the flow channels 62A and 62B are not blocked either. If the inspection shape 64 is blocked, it is highly likely that the flow channels 62A and 62B, even though they are more difficult to be blocked than the inspection shape 64, are blocked. Thus, it is determined that the device is defective. Alternatively, a detailed inspection such as an observation using a microscope along each flow channel may be performed later to determine the quality of bonding. On the other hand, it is easier to externally determine poor bonding due to the shortage of adhesive in bonding than in the above inspection, based on the generation of a large bubble. Thus, such an external inspection may be performed in advance.

Therefore, if the inspection shape 64 is not blocked, it is determined that the bonding is excellent, and the inspection is finished. Meanwhile, only a substrate in which blockage or partial blockage has been observed in the inspection shape 64 is extracted, and a further detailed inspection can be performed on the substrate later. In other words, it is not necessary to perform inspections on all of the flow channels of bonded substrates. As described above, it is possible to significantly reduce man-hours, such as the time required to perform the process of inspecting micro flow channels and the number of inspection items, which can be a bottleneck in the manufacturing process.

In a second exemplary embodiment, the shape of the inspection shape 64 will be discussed, and a shape that further facilitates an inspection will be described.

The inspection shape 64 in FIG. 6 may have, for example, the same cross-sectional dimensions as those of each of the flow channels 62A and 62B. Alternatively, the inspection shape 64 may be set as a shape that further facilitates the occurrence of blockage. For example, if the angle θ (65) formed by the bonding surface of the substrate 61 and the surface of the wall of the inspection shape 64 is 90° or more, this can make it easier for the adhesive 63 to enter the inspection shape 64 than the flow channels 62A and 62B, each of which forms an approximately right angle with the bonding surface of the substrate 61. The reason for this is as follows. When the substrates 60 and 61 are bonded together with the adhesive 63, at the vertex formed by the inspection shape 64 and the bonding surface of the substrate 61, a cosine component along the surface of the wall of the inspection shape 64, that is, the cosine component of a surface tension 67 on the contact surface between solid and gas with respect to the exterior angle of the angle 65, is larger than those of the flow channels 62A and 62B, and therefore acts in the direction of drawing the adhesive 63 into the inspection shape 64. In other words, the inspection shape 64 has a structure where the adhesive 63 flows more easily into the inspection shape 64 than into the flow channels 62A and 62B by the cosine component of the surface tension 67 with respect to the exterior angle of the angle 65.

Further, the depth of the inspection shape 64 can be set to be smaller than those of the flow channels 62A and 62B, as indicated by a depth 68. The depth of the depressed shape (i.e., inspection shape 64) is set to be smaller than those of the flow channels, whereby it is possible to reduce the amount of adhesive required for blockage. In other words, the inspection shape 64 that is blocked with a smaller amount of adhesive can be blocked in a shorter time, i.e., more easily, than the flow channels 62A and 62B. Similarly, the width of the inspection shape at the bonding surface may be set to be smaller than those of the flow channels 62A and 62B.

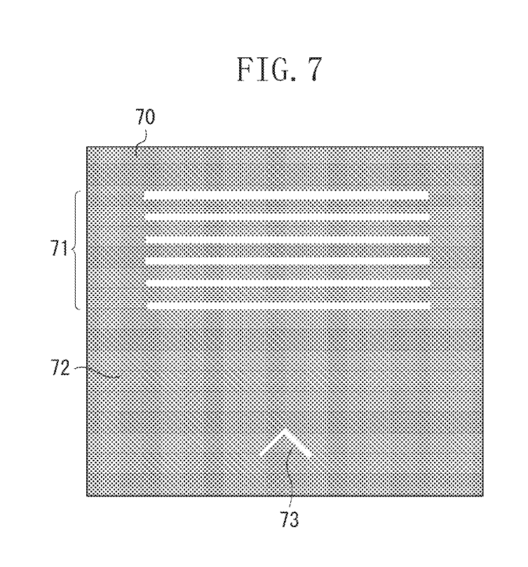

Further, it is possible to change the inspection shape to facilitate the occurrence of blockage. For example, as illustrated in FIG. 7, the inspection shape may be a V-shaped inspection shape 73. A substrate 70 includes grooves 71 and is bonded with another substrate via an adhesive 72. If the inspection shape 73 is formed into a V-shape in the direction of opposing the grooves 71, the apex of the V-shape facilitates the occurrence of blockage. This is because the adhesive 72 and a gas-liquid interface formed by the air in the inspection shape 73 and the adhesive 72 tend to form a line as straight as possible by pressure equilibrium. When bonding is inspected, it is possible, by observing that the adhesive 72 has not blocked the apex of the V-shaped inspection shape 73, to determine that the adhesive 72 has not entered the grooves 71.

As described above, according to the present exemplary embodiment, the distance from the wall of the closest flow channel is appropriately set and a shape of an inspection shape is devised, whereby it may be possible to complete an inspection only by observing the inspection shape. This can significantly reduce inspection man-hours.

A third exemplary embodiment will describe that an inspection shape does not necessarily need to be provided on a substrate.

When micro flow channels are manufactured by bonding substrates together with an adhesive, the blockage of the flow channels by the adhesive is a major issue. However, an air bubble formed in contact with each flow channel is also an issue. If an air bubble is in contact with each flow channel, the width of the flow channel may increase, or a solution may be accumulated in the air bubble. This impairs the reliability of the device. Further, if the size of the air bubble increases to such a size that adjacent flow channels are connected together, the device loses its function.

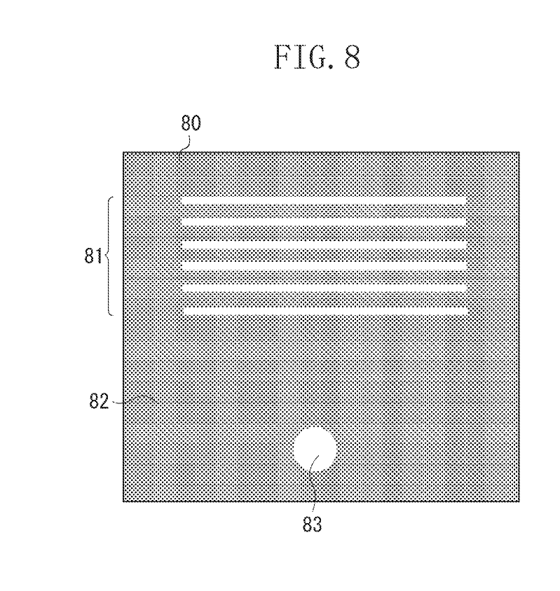

FIG. 8 illustrates a substrate 80 that includes grooves 81 and is bonded with another substrate via an adhesive 82 to form flow channels. The adhesive 82 has a thickness of several micrometers. Examples of the method for applying the adhesive 82 having this thickness include spray coating, spin coating, dip coating, and printing.

When the adhesive 82 is applied to the substrate 80 and if an approximately circular pattern is formed on a printing plate, the adhesive 82 can be applied to form a shape 83 by printing. If a plurality of substrates are bonded together, the shape 83 forms an air bubble at a position away from the flow channels 81. Further, the pattern may be formed by applying the adhesive 82 by spray coating, using a masking tape, and then removing the tape.

An air bubble existing, which is out of contact with a flow channel when substrates have been bonded together, is confined to a solution. Thus, the size of the air bubble changes depending on the balance between the internal pressures of the solution and the air bubble. When there is a difference (the Laplace pressure) between the internal pressure of the solution and the internal pressure of the air bubble, the relationship expressed by the following formula (14) is established, where the pressure difference is denoted as Δp, the surface tension of the gas-liquid interface is denoted as σ, and the radius of the air bubble is denoted as r.

Δp=2σ/r (14)

According to the above formula, if the radius r of the air bubble confined to the solution has been reduced even slightly by the internal pressure difference, the pressure difference Δp increases to adjust the Laplace pressure. This further reduces the size of the air bubble. Then, the internal pressure of the air bubble continuing to be reduced increases, and the air bubble dissolves in the solution according to Henry's law and disappears.

According to this principle, the shape 83 formed by applying the adhesive 82 is reduced by the internal pressure of the adhesive 82 and disappears. Thus, if the size of the shape 83 is larger than the size of other air bubbles generated when the substrates are bonded together, it is possible, by confirming the disappearance of the air bubble in the shape 83 before the adhesive 82 cures, to consider that other air bubbles have also disappeared. In other words, the shape 83 can be said to be an inspection shape for confirming the disappearance of air bubbles.

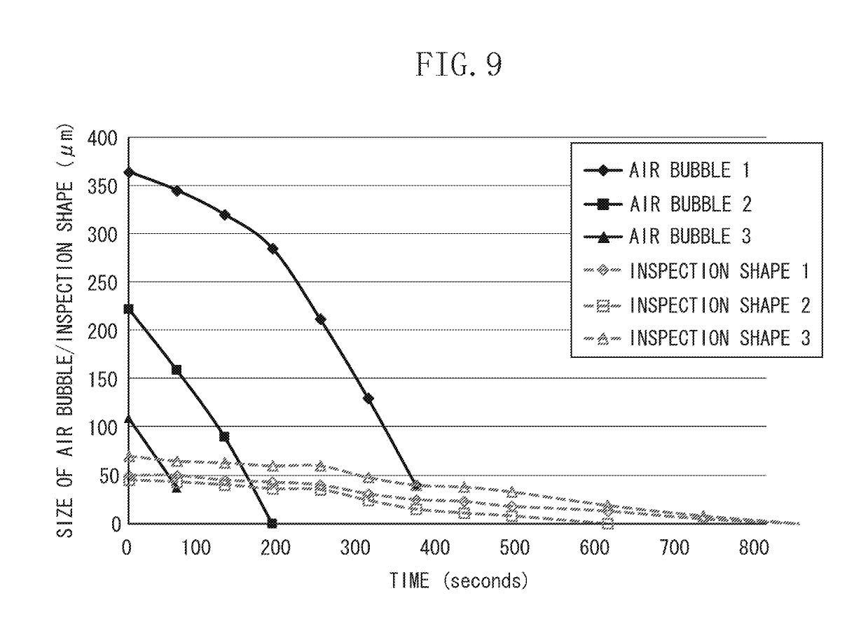

To confirm the above principle, air bubbles having diameters of approximately 30 to 70 micrometers were generated between substrates by printing application of an adhesive, and the disappearance times of the air bubbles were measured. Simultaneously, the sizes of air bubbles in contact with flow channels were also observed by obtaining images of the air bubbles. FIG. 9 illustrates the experimental result.

In a graph in FIG. 9, air bubbles 1 to 3 are air bubbles generated at positions in contact with flow channels when different substrates are bonded together using an ultraviolet curing adhesive. The vertical axis represents the diameter of an approximate circle of each of inspection shapes 1 to 3 generated by applying the ultraviolet curing adhesive, or the greatest distance in the normal direction between the gas-liquid interface of each of the air bubbles 1 to 3 and the flow channel. The horizontal axis represents the elapsed times after bonding for each of the air bubbles 1 to 3 and each of the inspection shapes 1 to 3.

The air bubbles 1 to 3 and the inspection shapes 1 to 3 have the following in common. The sizes thereof are reduced after the bonding, and the circular air bubbles and inspection shapes (the air bubbles 2 and 3 and the inspection shapes 1 to 3) are reduced almost linearly. However, the calculated speed of size reduction of each of the air bubbles 1 to 3 in contact with the flow channel was approximately 1.26 μm/second. The speed of size reduction of each of the inspection shapes 1 to 3 was 0.08 μm/second. In other words, the sizes of the inspection shapes 1 to 3 are reduced more slowly than those of the air bubbles 1 to 3. Thus, if the disappearance of the inspection shapes 1 to 3 has been confirmed, it can be said that the air bubbles 1 to 3 have already disappeared. The reason for this is as follows. The inspection shapes 1 to 3 are confined by the adhesive, and therefore, the air within the inspection shapes 1 to 3 gradually dissolves in the adhesive. On the other hand, the air bubbles 1 to 3 are in contact with the flow channels, and the pressure increased by the reduction in bubble size escapes to the flow channels. Thus, the sizes of the air bubbles 1 to 3 are reduced more quickly.

As described above, an air bubble purposely generated at a position out of contact with a flow channel is used as an inspection shape, whereby it is possible to confirm the disappearance of an air bubble in contact with the flow channel. Consequently, it is possible, by observing an inspection shape produced using an adhesive, to determine the quality of bonding without confirming the presence or absence of an air bubble in contact with an individual flow channel. This leads to a reduction in inspection man-hours.

A fourth exemplary embodiment will describe that an inspection shape produced using an adhesive does not necessarily need to be provided at a position away from a flow channel.

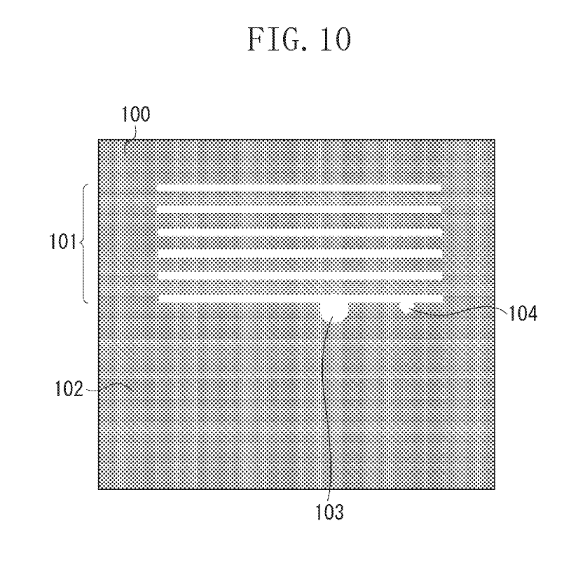

FIG. 10 illustrates a substrate 100 that includes grooves 101 and is bonded with another substrate via an adhesive 102 to form flow channels. an inspection shape 103, which is larger than an undesired air bubble 104 that has been generated in contact with one of the flow channels after the bonding, is provided. The inspection shape 103 can be patterned at a position in contact with the flow channel by a method such as printing.

When the substrate 100 to which the adhesive 102 has been applied by printing is bonded with another substrate, the air bubble 104 and the inspection shape 103 can be confirmed along the flow channel. After the substrates have been bonded together, the size of each of the inspection shape 103 and the air bubble 104 changes to be reduced by the internal pressure difference between the adhesive 102 and the air bubble during the time before the adhesive 102 cures. Thus, the size of the inspection shape 103 is set to be larger than the size of an air bubble that is normally generated, whereby it is possible to confirm the reduction of the air bubble 104 by confirming the reduction of the inspection shape 103.

In other words, the confirmation of the inspection shape 103 alone eliminates the need to individually confirm other air bubbles in contact with the flow channel. This can significantly reduce the inspection man-hours.

In the first to fourth exemplary embodiments, a bonding with an adhesive has been described. In any of the exemplary embodiments, it is possible to determine the quality of bonding before the adhesive cures. Thus, for example, a substrate that is poorly bonded can be removed from the manufacturing line without performing a post-process thereto. Consequently, a defective product is not sent to the post-process. This can eliminate the unnecessary manufacturing cost for the post-process.

A fifth exemplary embodiment will describe that the present invention is effective not only in a bonding method with an adhesive but also in a bonding method using thermocompression bonding.

As one of the methods for manufacturing micro flow channels, there is a method for thermocompression-bonding substrates together. Thermocompression bonding is a method for treating the surfaces of a substrate including grooves on its surface and another substrate as necessary, then overlapping the substrates with each other, pressurizing the substrates with the temperature raised to the approximate softening point of a resin, and forming bonding surfaces to manufacture hollow flow channels. In other words, thermocompression bonding can be said to be a method for integrating a plurality of substrates together by softening the bonding surfaces of the substrates.

Generally, when resin substrates are thermocompression-bonded together, the shape of a groove is crushed in the depth direction of the groove due to the softening of the surface of the substrate. In the case of a micro flow channel, the depth of the groove is several to several hundreds of micrometers in many cases, and therefore the depth of the groove is also affected by the softening of the surface of the substrate. The bonding strength of the substrates thermocompression-bonded by softening only several micrometers from the surface of the substrate is low. Thus, a fluid may leak to the bonding surface by continuous use, or the substrate may come off. On the other hand, the bonding strength of the substrate thermocompression-bonded by softening several hundreds of micrometers from the surface of the substrate is high, but the flow channel may be crushed.

Therefore, the depth of a groove for forming a micro flow channel is often designed taking into account the amount of crushing. However, even if a substrate including a groove having the designed depth is used, conventionally, it is only possible to determine the amount of crushing under specific thermocompression bonding conditions by measuring the depth of the flow channel after manufacturing. Only after it is determined, as a result of measuring the depth of the flow channel, that the determined amount of crushing is smaller than a predetermined amount of crushing, the quality of bonding can be determined.

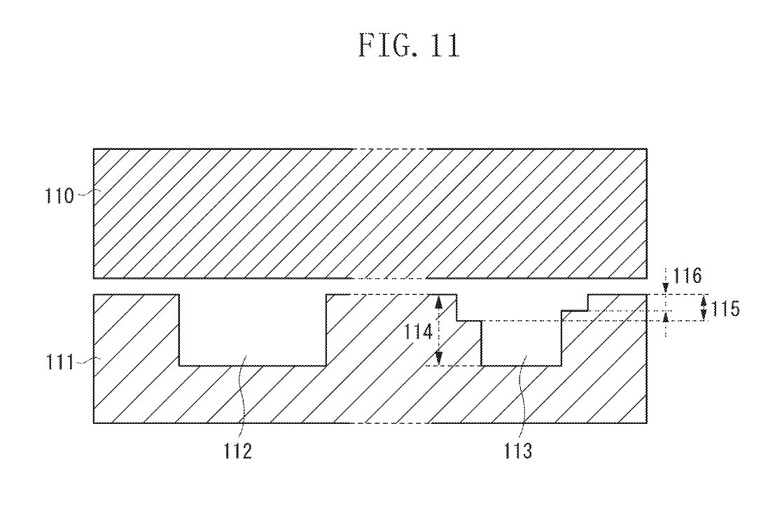

FIG. 11 illustrates an example of a cross-section of an inspection shape for bonding by thermocompression bonding according to the present invention. A substrate 110 is a flat plate and is bonded with a substrate 111 by thermocompression bonding. In the substrate 111, a flow channel 112 and an inspection shape 113 are formed. The inspection shape 113 includes a region having a depth 114, which is approximately equal to that of the flow channel 112, a region having a depth 116, which corresponds to an assumed amount of crushing, and a region having a depth 115, which is approximately 5 to 10 micrometers deeper than the depth 116. It is, however, desirable that the depth 115 should be determined based on variations in the amount of crushing.

Supposing that the substrates 110 and 111 have been thermocompression-bonded together and an excellent bonding result has been obtained. The depth 116, which corresponds to the predetermined amount of crushing, has disappeared after the bonding. The regions of the depths 114 and 115, however, partially remain even after the bonding, and therefore can be easily observed by visual inspection. At this time, it is understood that the depth of the flow channel 112 is approximately equal to the value obtained by subtracting the depth 116 from the depth 114, but is greater than the value obtained by subtracting the depth 115 from the depth 114.

Further, if the bonding is poor, the region of the depth 116 remains after the bonding. In this state, it is highly likely that the bonding strength is low. Another type of poor bonding is suspected when the region of the depth 115 has disappeared after the bonding. This state indicates that the bonding strength is high, but the depth 114 is smaller than a desired depth.

As described above, also in the case of bonding by thermocompression bonding, it is possible, using the inspection shape according to the present invention, to easily determine the quality of bonding without observing the depth of a flow channel. The bonding by thermocompression bonding is a method often employed when a micro flow channel is manufactured. The principle of the inspection shape according to the present invention, however, can also be used for a device formed by bonding substrates together by melting the surfaces of the substrates by ultrasonic welding or solvent bonding.

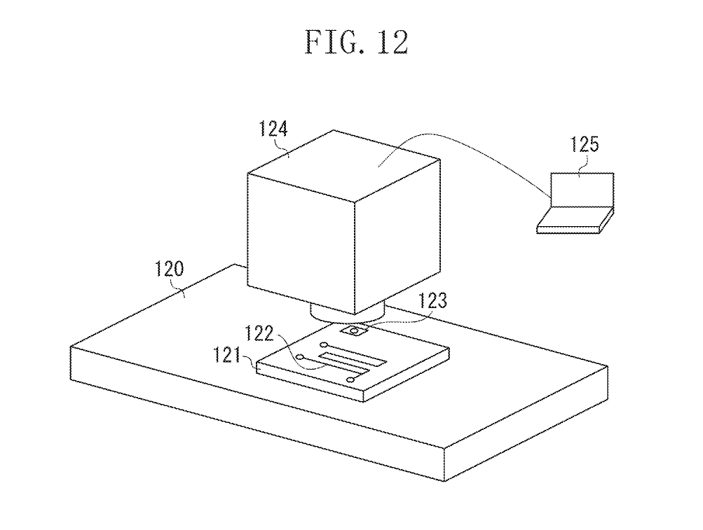

In the first to fifth exemplary embodiments, it is possible to automate the inspection using, for example, an inspection system as illustrated in FIG. 12. On a stage 120, a device 121 is provided at a position approximately directly under an imaging apparatus 124. In this case, on the stage 120, depressions and protrusions may be provided so that the positions of the imaging apparatus 124 and an inspection shape 123 approximately coincide with each other. With respect to a flow channel 122, an image of the inspection shape 123 is obtained by the imaging apparatus 124, and data is sent to an analysis apparatus 125. Data serving as a reference for bonding quality has been input in advance to the analysis apparatus 125 and is compared with the obtained image data. This enables the determination of the quality of bonding.

According to the present invention, it is possible to determine the quality of bonding only by observing the inspection shape 123. Thus, the imaging apparatus 124 does not need to scan the entire bonding surface of the device 121. Further, the imaging apparatus 124 can image the inspection shape 123 in such proximity to the inspection shape 123 that the inspection shape 123 is included in an imaging screen. Thus, it is possible to quickly inspect the bonding quality without reducing the resolution.

The present invention can be used to inspect a microfluidic device for performing a chemical reaction and a chemical analysis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-093890 filed Apr. 30, 2014, which is hereby incorporated by reference herein in its entirety.

What is claimed is:

1. A flow channel device, comprising: a plurality of hollow flow channels established by bonding substrates together in an overlapping manner, with at least one of the substrates including a plurality of grooves on a surface of the substrate, wherein
a depressed shape at which bonding quality can be determined is provided at a position different from positions of the flow channels on at least one of the surfaces of the bonded substrates.

2. The flow channel device according to claim 1, wherein the depressed shape is a depressed groove.

3. The flow channel device according to claim 1, wherein an angle formed by a bonding surface of the substrate and a surface of a wall of the depressed shape is greater than an angle formed by the bonding surface of the substrate and a surface of a wall of each of the flow channels.

4. The flow channel device according to claim 1, wherein a depth of the depressed shape is less than a depth of each of the flow channels.

5. The flow channel device according to claim 1, wherein a width of the depressed shape is less than a width of each of the flow channels.

6. The flow channel device according to claim 1, wherein the depressed shape includes at least one apex toward the flow channels.

7. The flow channel device according to claim 1, wherein the depressed shape has a plurality of depths, at least one of which is approximately equal to a depth of each of the flow channels and at least one of which is approximately equal to a depth of each of the flow channels changed in a depth direction by a pressure bonding.

8. The flow channel device according to claim 1, wherein the different position is a position satisfying a relationship expressed by a following formula (12):
$$L < \frac{{L}_{R} {W}_{D}^{2}}{( M + m ) g} \frac{T cos θ}{d} \qquad ( 12 )$$
where a distance from a wall of one of the flow channels is denoted as L, a thickness of a material used for the bonding is denoted as d, a surface tension of the material is denoted as T, a contact angle between the material and a surface of the substrate is denoted as θ, a mass of an object for pressurizing the other substrate is denoted as M, a width of the object is denoted as L_{R}, a mass of the other substrate is denoted as m, a width of the device is denoted as W_{D}, and a gravitational acceleration is denoted as g.

9. A method for manufacturing a flow channel device comprising:
bonding substrates together in an overlapping manner with an adhesive, at least one of the substrates including a groove on a surface of the substrate, such that including a hollow flow channel disposed therein; and
observing an air bubble surrounded by the adhesive, a size of which is reduced by bringing the substrates close to each other.

10. A method for inspecting bonding quality of a flow channel device including a hollow flow channel disposed therein by bonding substrates together in an overlapping manner, at least one of the substrates including a groove on a surface of the substrate, the method comprising:
generating an air bubble surrounded by an adhesive at a position different from a position of the flow channel; and
observing a reduction of a size of the air bubble.

11. A system for inspecting bonding of the flow channel device according to claim 1, the system comprising:
an apparatus for imaging the depressed shape; and
an analysis apparatus.
